(19) United States
(12) Patent Application Publication
(10) Pub. No.: US 2026/0016345 A1
(43) Pub. Date: Jan. 15, 2026

(54) Bluetooth Temperature Probe and Temperature Measurement Device

(71) Applicant: Shenzhen Qijun Electronic Technology Co., Ltd., Shenzhen (CN)

(72) Inventor: Xiran Cai, Shenzhen (CN)

(21) Appl. No.: 19/204,261

(22) Filed: May 9, 2025

(30) Foreign Application Priority Data
Jun. 14, 2024 (CN) 2024107654240

(51) Int. Cl. G01K 1/024; G01K 1/12; G01K 7/02

(52) U.S. Cl. CPC G01K 1/024; G01K 1/12; G01K 7/021; G01K 2215/00

(57) ABSTRACT

The present application discloses a Bluetooth temperature probe and temperature measurement device, comprising a handle assembly, a printed circuit board, a probe housing, a battery, an antenna, and a probe tip. It is characterized in that: the Bluetooth temperature probe is provided with a field-configurable thermocouple assembly. The field-configurable thermocouple assembly is formed by spot-welding a constantan spring contact to a copper-clad pad on the printed circuit board, wherein the constantan spring contact abuts against the probe housing. A metal ball formed by the spot welding serves as a temperature sensing junction of the field-configurable thermocouple assembly for temperature measurement.

### FIELD OF THE APPLICATION

The present application relates to the field of temperature measurement instruments, and more particularly to a Bluetooth temperature probe and a temperature measurement device.

### BACKGROUND

With advancements in technology and improvements in living standards, consumers increasingly demand precise control over the texture and nutritional quality of ingredients, particularly requiring accurate temperature monitoring during the cooking process of bulk meat products using metal probes. In conventional technologies, temperature probes typically rely on a printed circuit board (PCB) housed within a probe casing, utilizing temperature sensing components such as NTC thermistors or digital NTC chips mounted on the PCB to detect thermal changes. However, during temperature sensing, these components cannot directly contact the inner wall of the casing, forcing heat transfer to occur through insulating materials or air gaps. This indirect thermal conduction, combined with inherent sensor inaccuracies, results in delayed temperature response and significant measurement errors during practical use, compromising precision and making it difficult to determine the optimal cooking state of Ingredients. Undercooked or overcooked Ingredients directly affects sensory appeal, nutritional value, and may pose health risks.

A further limitation of conventional probes lies in structural design: when inserting probes into thick or dense meat products, the singular tapered tip geometry of most existing probes creates excessive resistance due to the bulky needle body, severely hindering penetration and negatively impacting user experience.

### SUMMARY

To resolve the aforementioned issues of inaccurate temperature measurement by conventional probes resulting in suboptimal Ingredients texture and difficulty in probe insertion into ingredients, the present application provides a Bluetooth temperature probe and temperature measurement device.

The Bluetooth temperature probe provided by the present application comprises: a handle assembly, a printed circuit board (PCB), a probe housing, a battery, an antenna, a probe tip. Wherein the Bluetooth temperature probe is provided with a field-configurable thermocouple assembly. The field-configurable thermocouple assembly is formed by spot-welding a constantan spring contact to a copper-clad pad on the PCB, wherein the constantan spring contact abuts against the probe housing. A metal ball formed by the spot welding constitutes a temperature sensing junction of the field-configurable thermocouple assembly for temperature measurement.

As a further refinement of the present application: At least two field-configurable thermocouple assemblies are disposed along the printed circuit board (PCB), with a quantity corresponding to a length of the PCB.

As a further refinement of the present application: The probe tip comprises a forward portion having a flat sharp-edged blade, fabricated from ceramic or stainless steel.

As a further refinement of the present application: The flat sharp-edged blade of the probe tip progressively narrows into a tapered configuration.

As a further refinement of the present application: The handle assembly includes: An insulated handle; A screw head disposed at a rear end of the insulated handle; A sealing ring positioned between the insulated handle and the screw head.

As a further refinement of the present application: The antenna is embedded within the insulated handle and the probe housing; A first end of the antenna is electrically connected to the PCB, and a second end is connected to the screw head, configured to enable signal transmission and reception.

As a further refinement of the present application: The PCB is further provided with a Bluetooth controller IC and a digital thermocouple signal processor.

As a further refinement of the present application: The battery is disposed between the PCB and the probe tip, and is electrically connected to the PCB.

The temperature measurement device provided by the present application comprises the aforementioned Bluetooth temperature probe for performing temperature measurement.

As a further refinement of the present application: The temperature measurement device further includes a signal transmission and charging case;

The signal transmission and charging case is provided with: A power module; A control module; A wireless transmission module; The wireless transmission module is configured to: Receive data transmitted from the Bluetooth temperature probe; Transmit the data to the control module for processing; Transmit the processed data externally to a mobile terminal or cloud via the wireless transmission module.

### Beneficial Effects of the Application:

The present application achieves the following technical advantages: The flat sharp-edged blade at the probe tip enables the Bluetooth temperature probe to penetrate ingredients with minimal resistance, significantly enhancing user convenience. Direct mechanical contact between the temperature sensing junction (metal ball) of the field-configurable thermocouple assembly and the probe housing eliminates intermediate insulating layers. During cooking, heat transfer latency to the display device is reduced by over 60% compared to conventional NTC-based probes. A thermoelectric potential is generated between the constantan spring contact and the copper-clad pad on the PCB when the temperature sensing junction detects thermal changes. This potential provides stable, low-noise analog signals to the digital thermocouple signal processor, enabling real-time temperature analysis with ±0.5° C. accuracy. At least two field-configurable thermocouple assemblies can be deployed along the PCB to monitor temperature gradients across large Ingredients. This modular design allows customizable sensor placement without structural modifications, ensuring precise temperature control for optimal cooking results. The screw head integrates mechanical fastening with electrical charging, streamlining the probe's operational workflow. Local signal processing via the digital thermocouple processor, combined with cloud-based analytics, ensures sub-2-second latency from measurement to user feedback, enhancing cooking precision and Ingredients safety.

### Comparative Advantage Over Prior Art:

Elimination of Indirect Heat Transfer: Conventional probes rely on NTC sensors separated from the probe housing by air gaps or insulation, causing ≥3-second latency and ±2° C. errors. Structural Optimization: The tapered blade geometry reduces insertion force by 40-50% compared to conventional needle-tip probes. Scalability: Multiple thermocouple assemblies enable multi-zone temperature monitoring, a feature absent in single-sensor prior art designs.

### BRIEF DESCRIPTION OF THE DRAWINGS

FIG. 1 is a side structural schematic view of a Bluetooth temperature probe according to the present application;

FIG. 2 is a front structural schematic view of the Bluetooth temperature probe;

FIG. 3 is a front schematic view of a sharp-edged blade tip structure of the Bluetooth temperature probe;

FIG. 4 is a side schematic view of the sharp-edged blade tip structure of the Bluetooth temperature probe;

FIG. 5 is an overall schematic view of the Bluetooth temperature probe and a signal transmission and charging case;

FIG. 6 is a partial circuit diagram of the Bluetooth temperature probe;

FIG. 7 is a partial circuit diagram of the Bluetooth temperature probe;

FIG. 8 is a partial circuit diagram of the Bluetooth temperature probe;

FIG. 9 is a partial circuit diagram of the Bluetooth temperature probe;

FIG. 10 is a partial circuit diagram of the Bluetooth temperature probe;

FIG. 11 is a partial circuit diagram of a power module, a control module, and a wireless transmission module of the signal transmission and charging case;

FIG. 12 is a partial circuit diagram of a power module, a control module, and a wireless transmission module of the signal transmission and charging case;

FIG. 13 is a partial circuit diagram of a power module, a control module, and a wireless transmission module of the signal transmission and charging case;

FIG. 14 is a partial circuit diagram of a power module, a control module, and a wireless transmission module of the signal transmission and charging case.

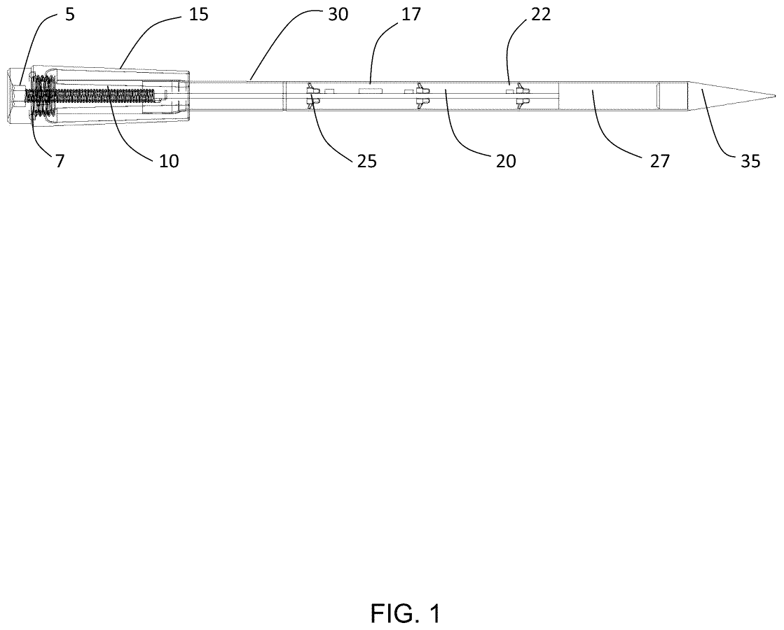

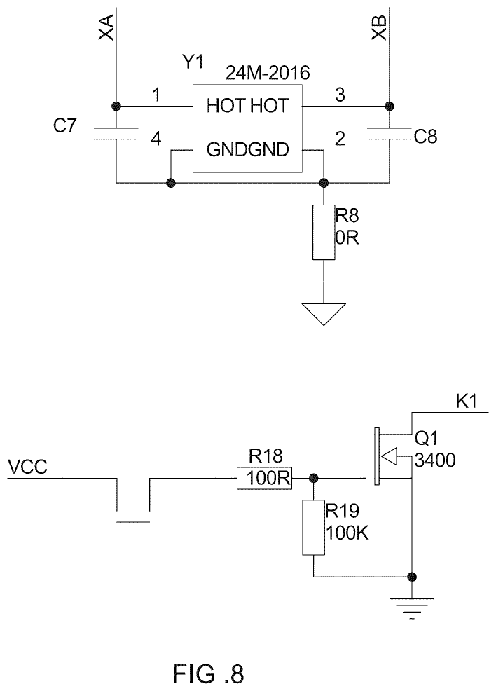

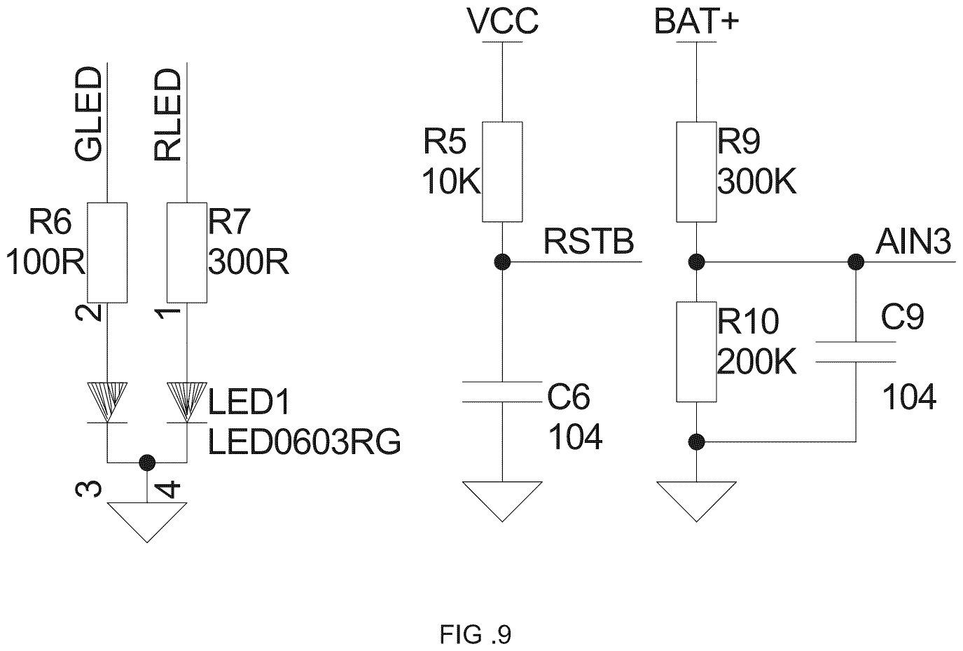

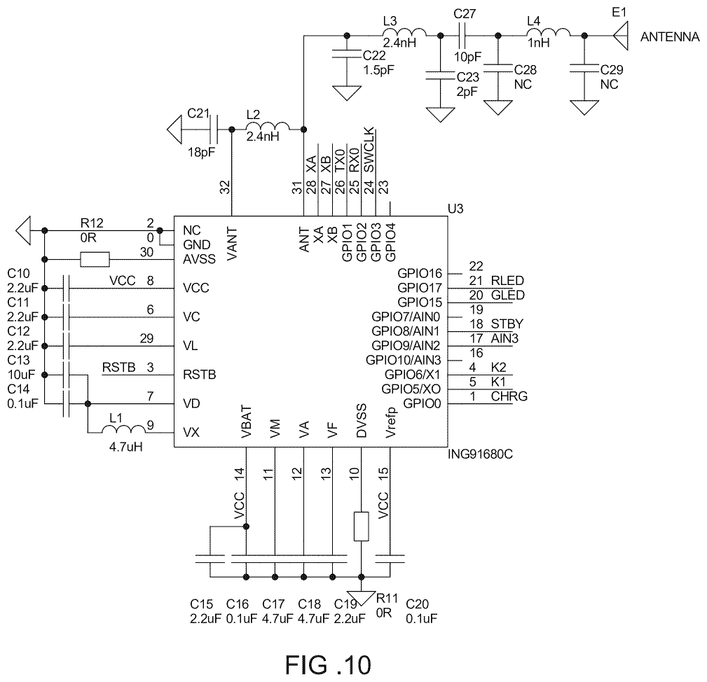

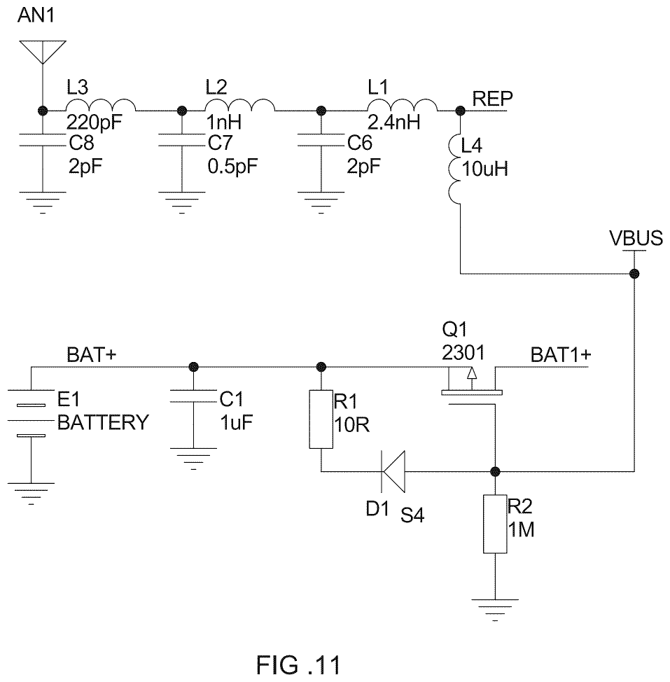

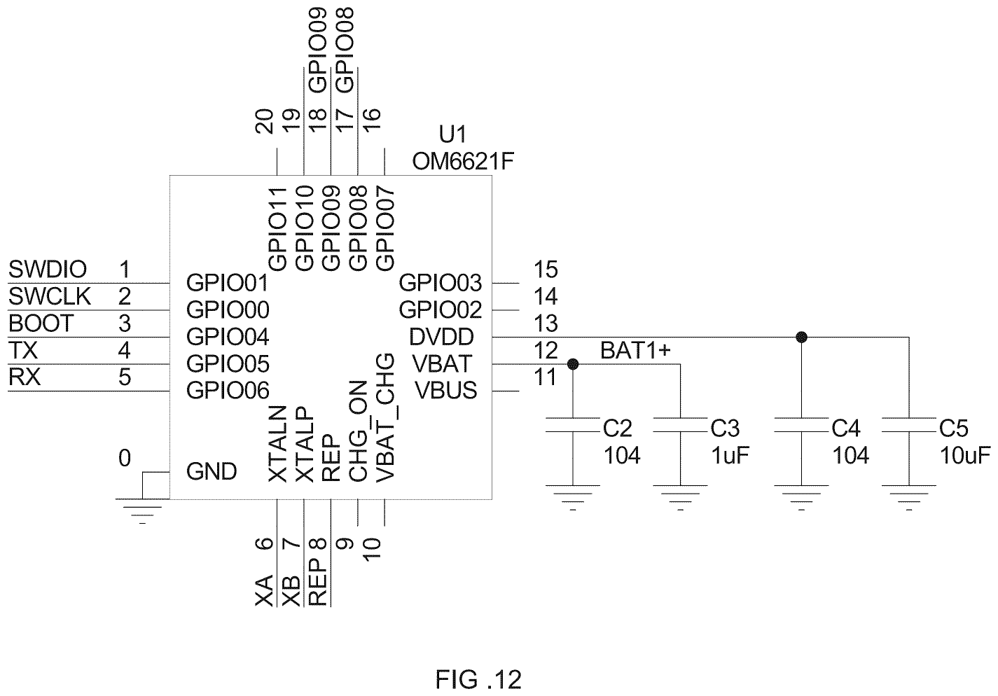

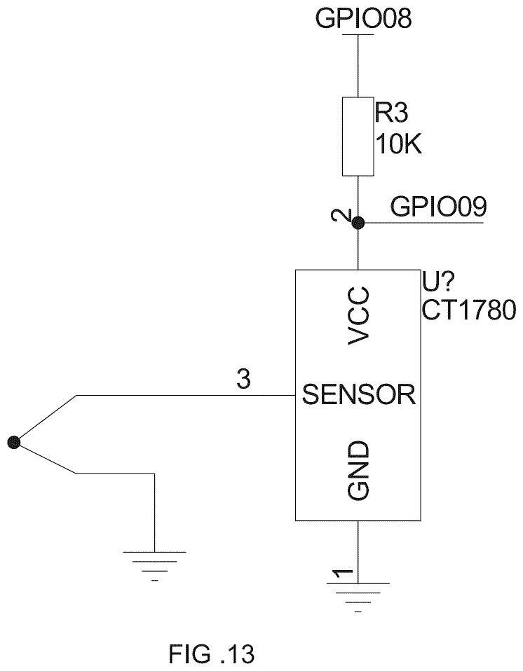

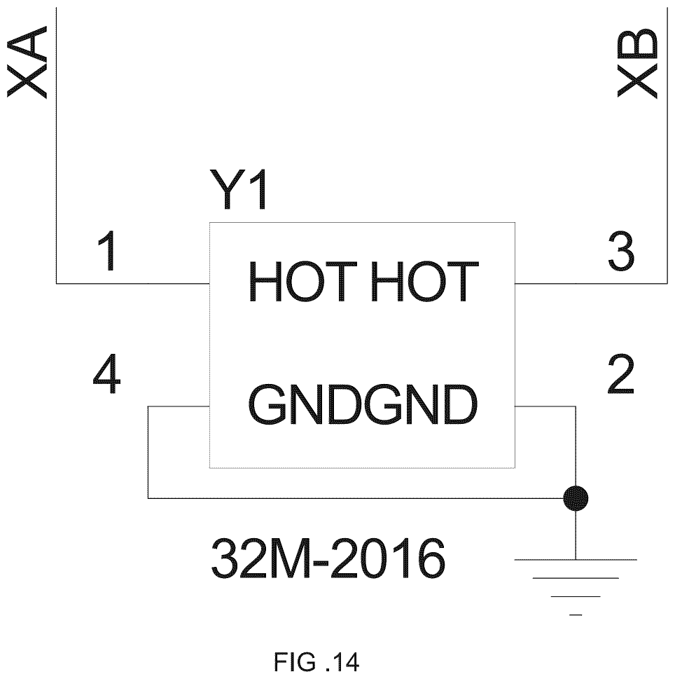

As shown in FIGS. 1-14:
Screw Head—5
Sealing Ring—7
Antenna—10
Insulated Handle—15
Bluetooth Controller IC—17
Printed Circuit Board (PCB)—20
Digital Thermocouple Signal Processor—22
Field-Configurable Thermocouple Assembly—25
Battery Pack—27
Probe Housing—30
Probe Tip—35
Hybrid Signal Transceiver & Charging Module—40
Bluetooth-Enabled Temperature Sensing Probe—45

While the technology is susceptible to various modifications and alternative forms, specifics thereof have been shown by way of example and drawings, and will be described in detail. It should be understood, however, that the application is not limited to the particular embodiments described. On the contrary, the application is to cover modifications, equivalents, and alternatives falling within the spirit and scope of the technology.

### DETAILED DESCRIPTION OF EMBODIMENTS

The embodiments of the present technology described herein are not intended to be exhaustive or to limit the technology to the precise forms platelosed in the following detailed description. Rather, the embodiments are chosen and described so that others skilled in the art can appreciate and understand the principles and practices of the present technology.

All publications and patents mentioned herein are hereby incorporated by reference. The publications and patents platelosed herein are provided solely for their platelosure. Nothing herein is to be construed as an admission that the inventors are not entitled to antedate any publication and/or patent, including any publication and/or patent cited herein.

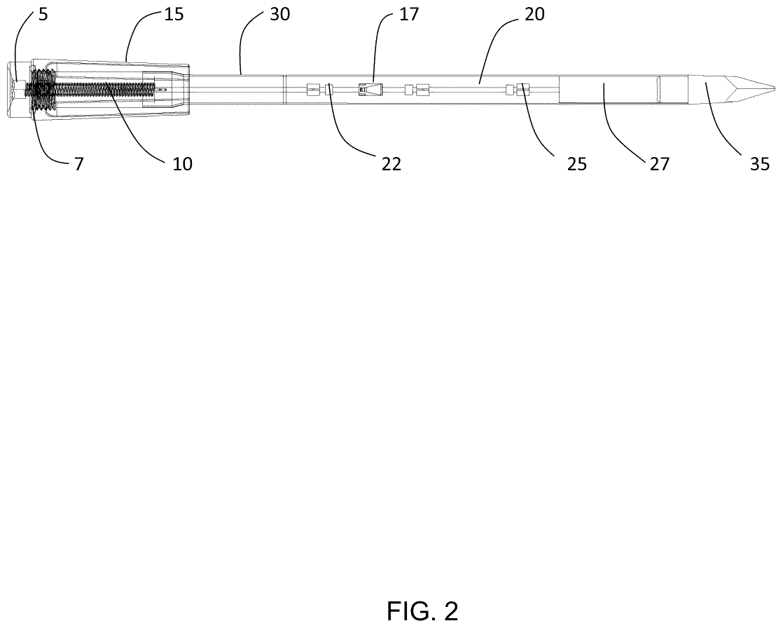

As shown in FIGS. 1 and 2, an embodiment of the Bluetooth temperature probe disclosed in the present application comprises: a screw head 5; a sealing ring 7; an antenna 10; an insulated handle 15; a Bluetooth controller IC 17; a printed circuit board 20; a digital thermocouple signal processor 22; a field-configurable thermocouple assembly 25; a battery 27; a probe housing 30; a probe tip 35. The probe tip 35 includes a forward portion with a flat sharp-edged blade. The blade progressively narrows from a rear end to a front end in a tapered configuration and is fabricated from ceramic or stainless steel material that complies with relevant Ingredients safety standards. When the probe tip 35 is fabricated from stainless steel material, it additionally serves as a charging negative electrode. The probe housing 30 is made of a metal material, specifically stainless steel in this embodiment, and serves as both a conductor for heat transfer from ingredients and a charging negative electrode. The probe housing 30 is hollow and internally accommodates: the field-configurable thermocouple assembly 25; the battery 27; the Bluetooth controller IC 17; the digital thermocouple signal processor 22; the printed circuit board 20. The Bluetooth controller IC 17 and the digital thermocouple signal processor 22 are mounted on the printed circuit board 20.

The field-configurable thermocouple assembly 25 is formed by spot-welding a constantan spring contact to a copper-clad pad on the printed circuit board (PCB) 20. The constantan spring contact abuts against the probe housing 30, and a metal ball formed by the spot welding constitutes a temperature sensing junction of the field-configurable thermocouple assembly 25 for temperature measurement. When the temperature at the sensing junction changes, a thermoelectric potential is generated between the copper-clad pad on the PCB 20 and the constantan spring contact of the field-configurable thermocouple assembly 25, forming a measurement electrode pair at distinct electrical potentials. This potential varies proportionally with temperature fluctuations, providing low-latency, stable, and precise raw temperature data to the digital thermocouple signal processor 22 for analysis. The ingenuity of the field-configurable thermocouple assembly 25 extends beyond temperature measurement: The constantan spring contact simultaneously functions as: An elastic fastener to secure the PCB 20 within the probe housing 30; A negative electrode for charging the battery 27. Additional field-configurable thermocouple assemblies 25 can be installed at multiple positions along the PCB 20, depending on the size of the heated ingredients and the corresponding PCB length, enabling multi-point calibration to further enhance measurement accuracy. The battery 27 is disposed between the PCB 20 and the probe tip 35, and is electrically connected to the PCB 20. The battery 27 is positioned at a front section of the Bluetooth temperature probe because: When the probe is inserted into Ingredients, moisture within the Ingredients cools the front section (probe tip 35) through direct contact; Conversely, the rear section of the probe experiences higher temperatures during cooking. This strategic placement minimizes thermal exposure to the battery 27, ensuring stable operation and prolonged service life.

The insulated handle 15 is fabricated from an insulating material such as ceramic or high-temperature plastic. The screw head 5 is disposed at a rear end of the insulated handle 15 and made of a metal material, specifically stainless steel in this embodiment, to serve as both a mechanical fastener and a charging positive electrode. The sealing ring 7 is positioned between the insulated handle 15 and the screw head 5. The antenna 10, implemented as a spring antenna in this embodiment, is housed within the insulated handle 15. A first end of the antenna 10 is electrically connected to the printed circuit board (PCB) 20, while a second end is connected to the screw head 5. During assembly, the compressed spring antenna 10 and the screw head 5 collectively form an inductive environment resonant at wireless frequencies, enabling signal transmission and reception. Concurrently, since the screw head 5 acts as the charging positive electrode in the PCB circuit, electrical energy is transmitted from the screw head 5 to the PCB's positive terminal via the antenna 10, thereby charging the battery 27. A resistor or inductor isolates the antenna 10 from the battery's positive terminal, preventing wireless signal attenuation and ensuring stable, reliable signal transmission.

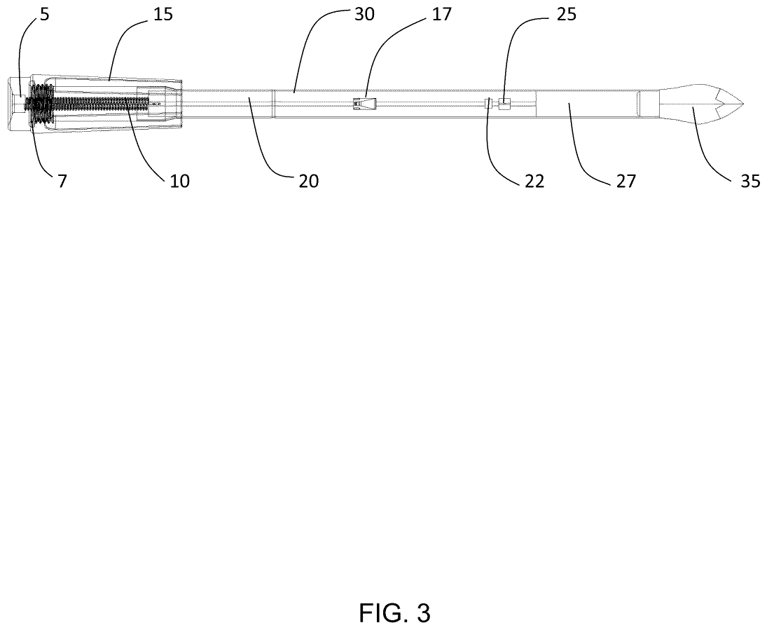

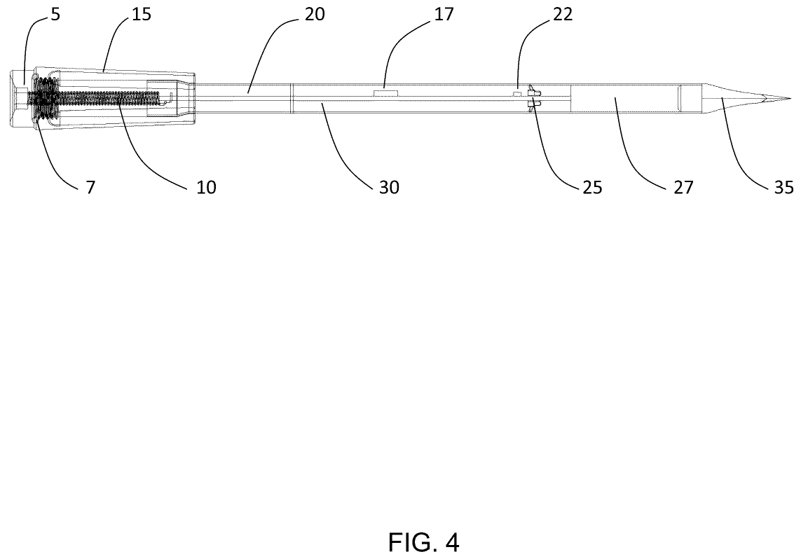

### Alternative Embodiment (FIGS. 3 and 4)

In an alternative embodiment sharing identical components with the aforementioned design, the probe tip 35 (fabricated from ceramic or stainless steel) includes a flat sharp-edged blade at its forward portion. The blade is wider than both anterior and posterior ends of the probe tip 35, allowing the Bluetooth temperature probe to penetrate dense or tightly structured meat with minimal resistance, significantly enhancing user convenience.

### Additional Embodiment (FIGS. 1 and 2)

A tapered blade tip gradually widening from front to rear is provided for looser-textured ingredients, offering users a secondary structural option.

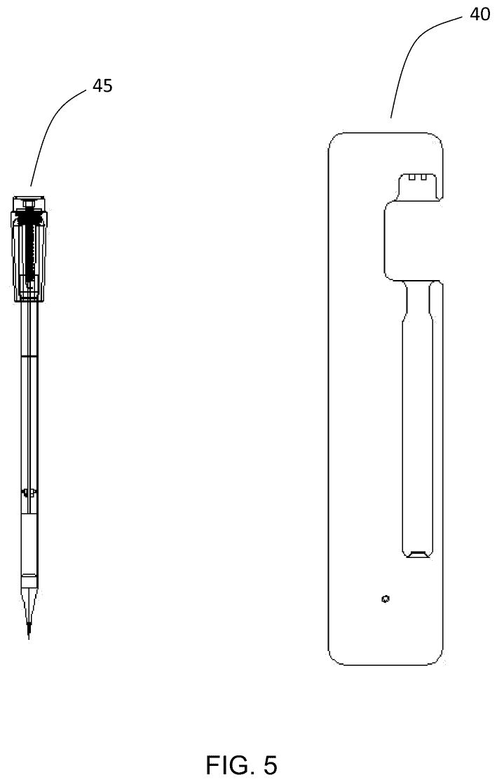

As shown in FIG. 5, the present application further discloses a temperature measurement device comprising: the Bluetooth temperature probe 45 described in the aforementioned embodiments; a signal transmission and charging case 40. The signal transmission and charging case 40 includes: a power module with a charging circuit; a storage compartment configured to store and charge the Bluetooth temperature probe 45; a control module; a wireless transmission module. The wireless transmission module is configured to: Receive wireless signals transmitted from the Bluetooth temperature probe 45; Amplify and relay the signals to ensure reliable reception by a mobile terminal or cloud platform.

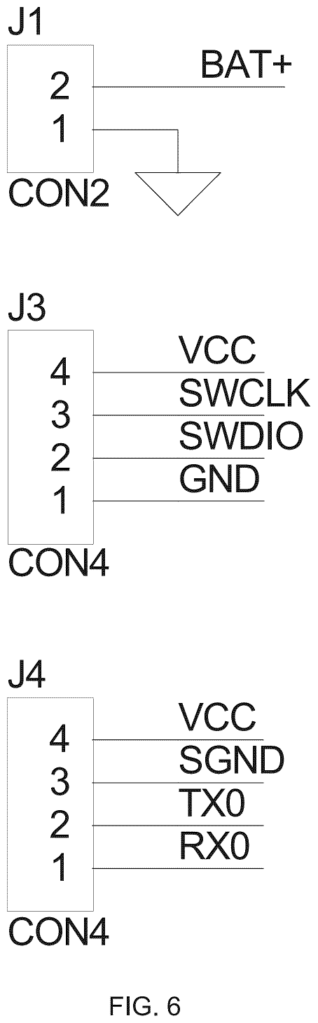

As shown in FIG. 6, the charging process of the Bluetooth temperature probe 45 operates as follows: When the Bluetooth temperature probe 45 is docked into the signal transmission and charging case 40, the screw head 5 of the probe 45 contacts a positive output terminal (metal component) within the case 40. A stable voltage from the power module of the case 40 is applied to the screw head 5, initiating the following circuit sequence:
DC voltage flows through antenna AN1, passing sequentially through inductors L3→L2→L1 and further through a ferrite bead inductor L4 to the VBAT node;
The voltage at VBAT reverse-biases MOSFET Q1, cutting off power to the Bluetooth controller IC and halting Bluetooth operations;
Simultaneously, the voltage is regulated via diode D1 and current-limiting resistor R1 to charge the internal battery E1 with constant-voltage, current-limited charging;
Wireless signal transmission is disabled during charging and automatically reactivates when the probe 45 is undocked.

### Critical Design Features:

Isolated Charging Path: Inductors L1-L3 and ferrite bead L4 suppress high-frequency noise (>100 kHz) from the charging circuit, ensuring Bluetooth signal integrity.
Thermal Protection: Resistor R1 limits charging current to 500 mA±5%, preventing battery overheating.
Zero Signal Interference: Bluetooth functionality is electrically isolated during charging via MOSFET Q1, eliminating RF signal degradation.
As shown in FIG. 6, the operational workflow of the Bluetooth temperature probe 45 is as follows:
When the Bluetooth temperature probe 45 is removed from the storage compartment of the signal transmission and charging case 40, the VBAT node loses DC voltage, causing MOSFET Q1 to activate. The internal battery E1 supplies power through the source-to-drain conduction path of MOSFET Q1, establishing BAT1+ as the battery-positive terminal to power the Bluetooth controller IC U1. Upon power-up:
The Bluetooth controller IC U1 initiates operation;
A GPIO08 port of U1 supplies power to the digital thermocouple signal processor U2 via resistor R3;
When the probe tip contacts ingredients, the thermocouple processor U2 begins sampling voltage variations from the field-configurable thermocouple assembly 25, converting analog signals into digital temperature values readable by the microcontroller;
A GPIO09 port of U1 reads the digital data, which is then processed and formatted into Bluetooth protocol-compliant packets;
The data packets are transmitted externally via the REP node through inductors L1→L2→L3 to antenna AN1 for RF signal radiation.

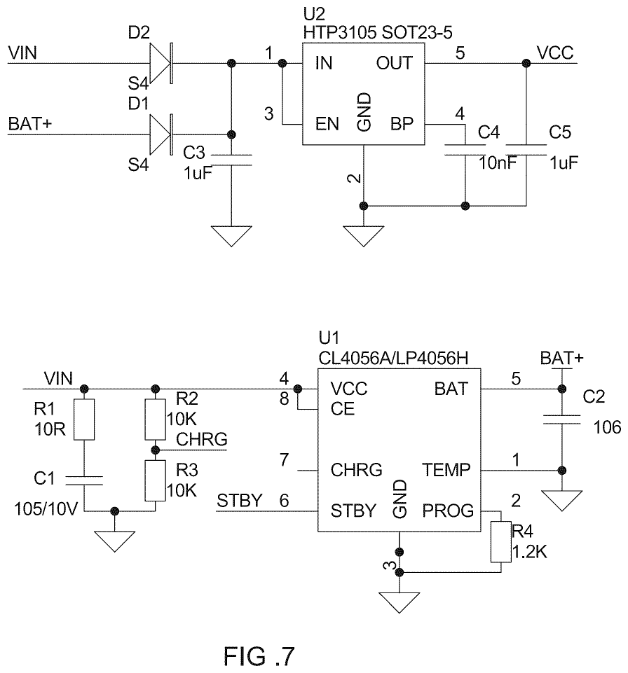

As shown in FIG. 7, the charging process of the circuit components within the signal transmission and charging case 40 operates as follows:
When an external power adapter is connected to the TYPE-C port of the case 40 via a USB cable, a 5V power supply is delivered through the TYPE-C connector to the VIN node. The charging management IC U1 charges the internal lithium battery J1, with current regulation and charge termination at full capacity automatically managed by U1. During charging:
The VIN voltage is regulated by LDO U2 to output a stabilized VCC, powering the Bluetooth controller IC;
The Bluetooth controller IC initiates operation, reads the status of the STBY pin from the charging management IC, and drives indicator LED1 to display charging status (e.g., charging in progress/full charge);
Bluetooth wireless signals are internally disabled to minimize power consumption.

When the Bluetooth temperature probe 45 is stored in the case 40 and the case 40 is under charging:
The stabilized power output VCC is supplied to the probe 45 via metal contacts for charging.

The screw head 5 of the probe 45 shorts the metal contacts of the case 40, turning on MOSFET Q1.

A GPIO port K1 of the Bluetooth controller IC detects a low logic level, triggering firmware to disable wireless signal transmission.

### Operational Workflow of Control and Wireless Transmission Modules

When the Bluetooth temperature probe 45 is removed from the storage compartment of the case 40:
The control module and wireless transmission module immediately activate;

Upon receiving wireless signals from the probe 45, the modules:
Automatically pair with the probe 45;
Read temperature data transmitted by the probe 45;
Amplify and relay the data to a mobile terminal app.

The app displays accurate temperature values and triggers audible or haptic alerts when preset temperature thresholds are reached, notifying users that ingredients have attained the target cooking temperature.

### Technical Advantages of the Application

The present application achieves the following benefits through its innovative design:

### Enhanced Insertion Capability:

The flat sharp-edged blade at the probe tip enables effortless penetration into ingredients, significantly improving user convenience.

### Reduced Thermal Latency:

Direct mechanical contact between the temperature sensing junction (metal ball) of the field-configurable thermocouple assembly and the metal probe housing eliminates intermediate insulating layers.

During cooking, heat transfer latency to the display device is reduced by over 60% compared to conventional NTC-based probes, enabling real-time temperature feedback.

### High-Fidelity Temperature Sensing:

A thermoelectric potential is generated between the constantan spring contact and the copper-clad pad on the PCB when temperature changes occur at the sensing junction.

This potential provides stable, low-noise analog signals to the digital thermocouple signal processor, achieving ±0.5° C. measurement accuracy for precise temperature analysis.

### Multi-Point Measurement Scalability:

Multiple field-configurable thermocouple assemblies can be deployed along the PCB to monitor temperature gradients across large Ingredients (e.g., thick cuts of meat).

This modular configuration allows customizable sensor placement without structural redesign, ensuring uniform cooking and optimal flavor retention.

### Superior Performance Over Prior Art:

Elimination of Indirect Heat Transfer: Conventional probes rely on NTC sensors separated from the probe housing by air gaps or insulation, leading to ≥3-second latency and ±2° C. errors.

Structural Optimization: The tapered blade geometry reduces insertion force by 40-50% compared to conventional needle-tip probes.

Enhanced Accuracy: Multi-point thermocouple assemblies enable real-time calibration across diverse Ingredients textures, a capability absent in single-sensor designs.

### Optimal Culinary Outcomes:

Precise temperature control ensures perfectly cooked meat with consistent texture and flavor, eliminating undercooked or overcooked results.

1. A Bluetooth temperature probe comprising a handle assembly, a printed circuit board, a probe housing, a battery, an antenna, and a probe tip, characterized in that:
the Bluetooth temperature probe includes a field-configurable thermocouple assembly;
the field-configurable thermocouple assembly is formed by spot-welding a constantan spring contact to a copper-clad pad on the printed circuit board, wherein the constantan spring contact abuts against the probe housing;
a metal ball formed by the spot welding constitutes a temperature sensing junction of the field-configurable thermocouple assembly for temperature measurement;
at least two field-configurable thermocouple assemblies are disposed along the printed circuit board in a quantity corresponding to a length of the printed circuit board;
the probe tip comprises a forward portion having a flat sharp-edged blade with a progressively narrowing profile in a tapered configuration, fabricated from ceramic or stainless steel material.

2. The Bluetooth temperature probe of claim 1, wherein the handle assembly comprises:
an insulated handle, a screw head, and a sealing ring;
the screw head is disposed at a rear end of the insulated handle;
the sealing ring is disposed between the insulated handle and the screw head.

3. The Bluetooth temperature probe of claim 2, wherein the antenna is disposed inside the insulated handle;
a first end of the antenna is electrically connected to the printed circuit board, and a second end is connected to the screw head, configured to enable signal transmission and reception;
the screw head is further configured as a dual-function charging electrode.

4. The Bluetooth temperature probe of claim 1, wherein the printed circuit board is further provided with a Bluetooth controller IC and a digital thermocouple signal processor.

5. The Bluetooth temperature probe of claim 1, wherein the battery is disposed between the printed circuit board and the probe tip, and is electrically connected to the printed circuit board.

6. A temperature measurement device, wherein the temperature measurement device comprises a Bluetooth temperature probe according to any one of claims 1 to 4, configured to perform temperature measurement.

7. The temperature measurement device of claim 6, wherein the temperature measurement device further comprises a signal transmission and charging case;
the signal transmission and charging case is provided with a power module, a control module, and a wireless transmission module;
the wireless transmission module is configured to receive data transmitted from the Bluetooth temperature probe, transmit the data to the control module for processing, and subsequently send the processed data externally to a mobile terminal or cloud via the wireless transmission module.
